(19) United States
(12) Patent Application Publication
(10) Pub. No.: US 2017/0200232 A1
(43) Pub. Date: Jul. 13, 2017

(54) Charitable BitMints

(71) Applicant: Gideon Samid, Rockville, MD (US)

(72) Inventor: Gideon Samid, Rockville, MD (US)

(21) Appl. No.: 15/401,073

(22) Filed: Jan. 8, 2017

Related U.S. Application Data
(60) Provisional application No. 62/276,893, filed on Jan. 10, 2016.

(51) Int. Cl. G06Q 40/06; G06Q 20/10; G06Q 30/02; G06Q 20/06

(52) U.S. Cl. CPC G06Q 40/06; G06Q 20/065; G06Q 20/102; G06Q 30/0279

(57) ABSTRACT

This invention combines digital money constructs with investment instruments to achieve an economic leverage in favor of target charitable causes. It is based on the fact the digital tokens, representing claim checks for cash, may be traded like cash while the cash itself is used elsewhere.

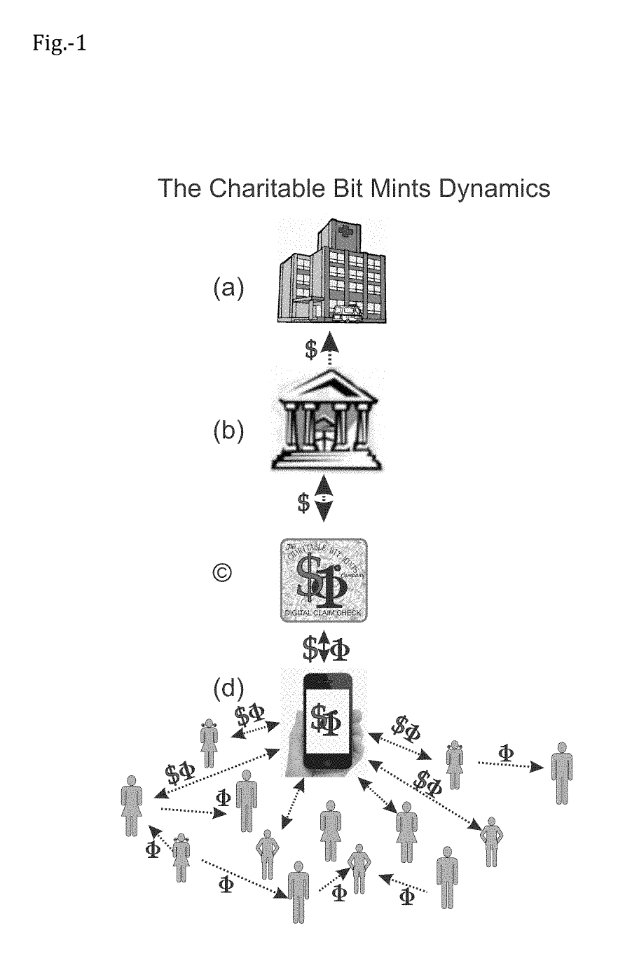

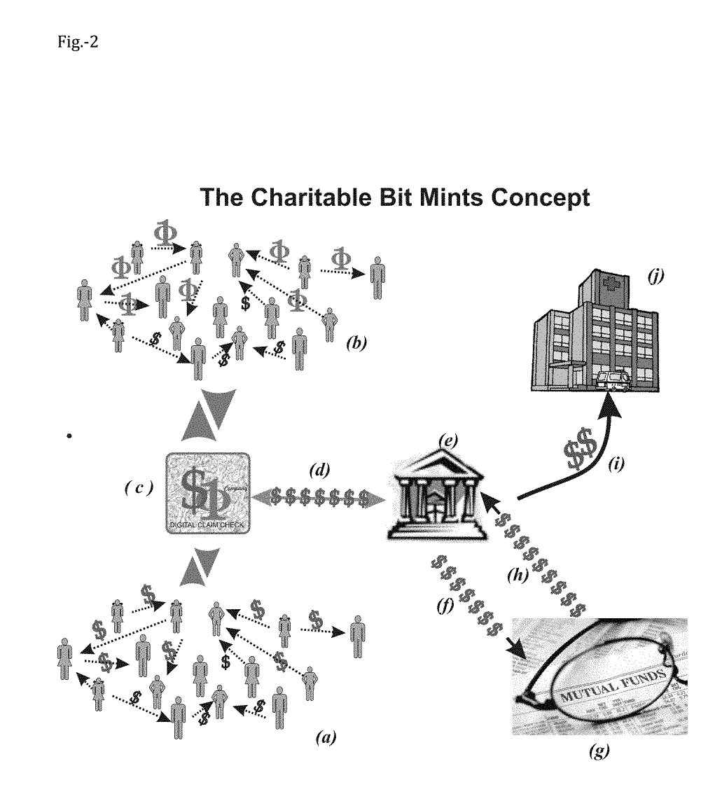

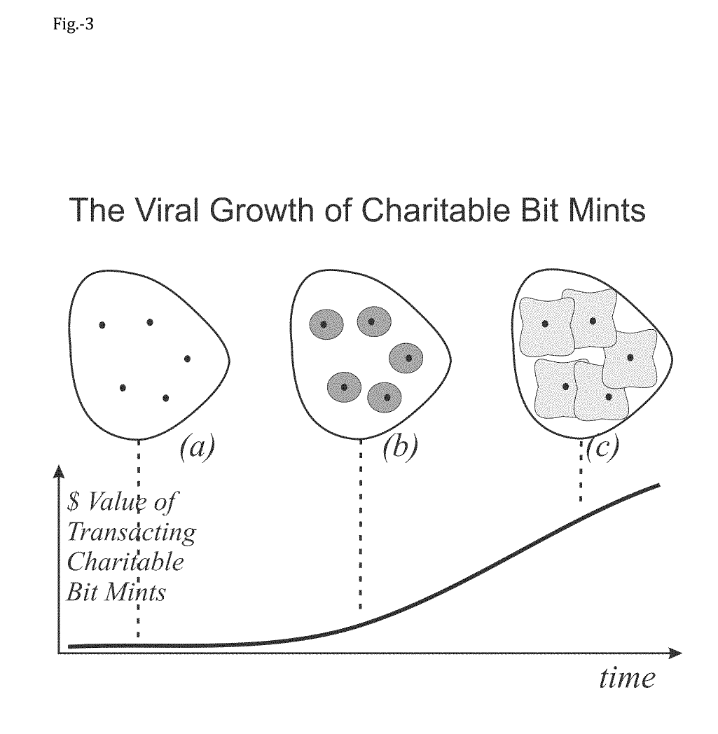

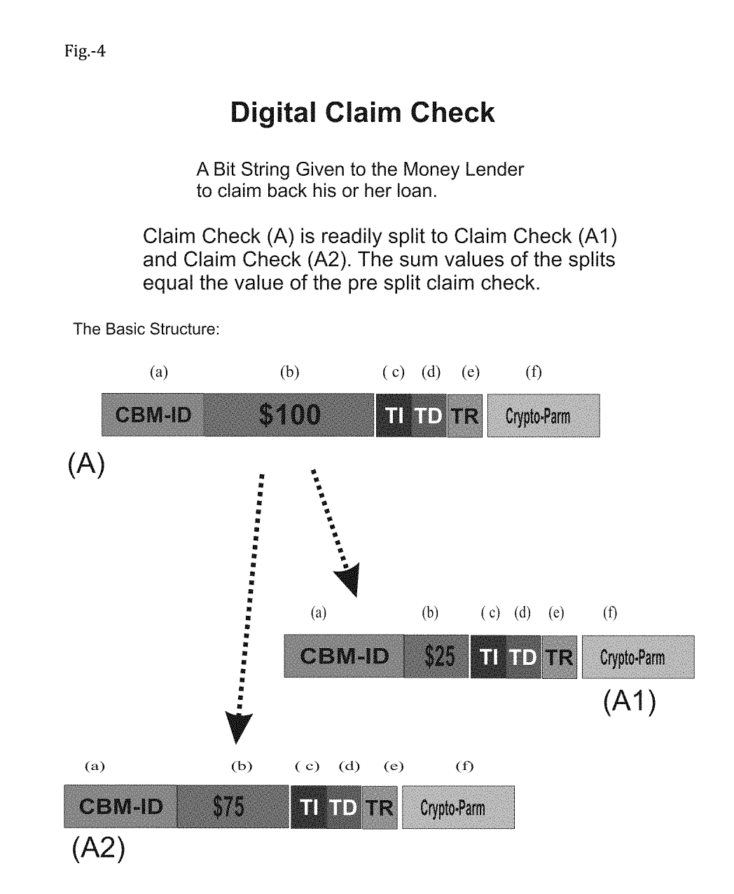

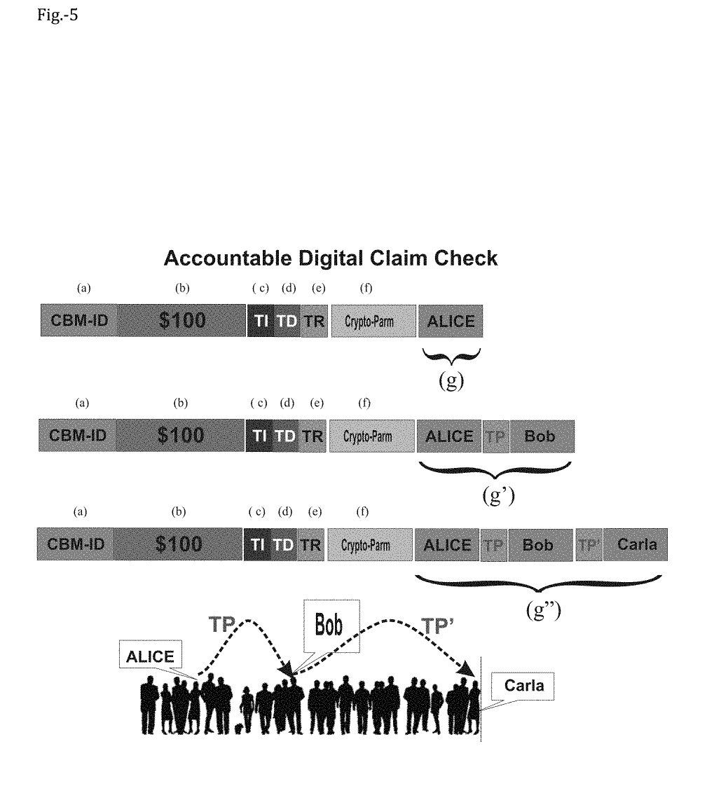

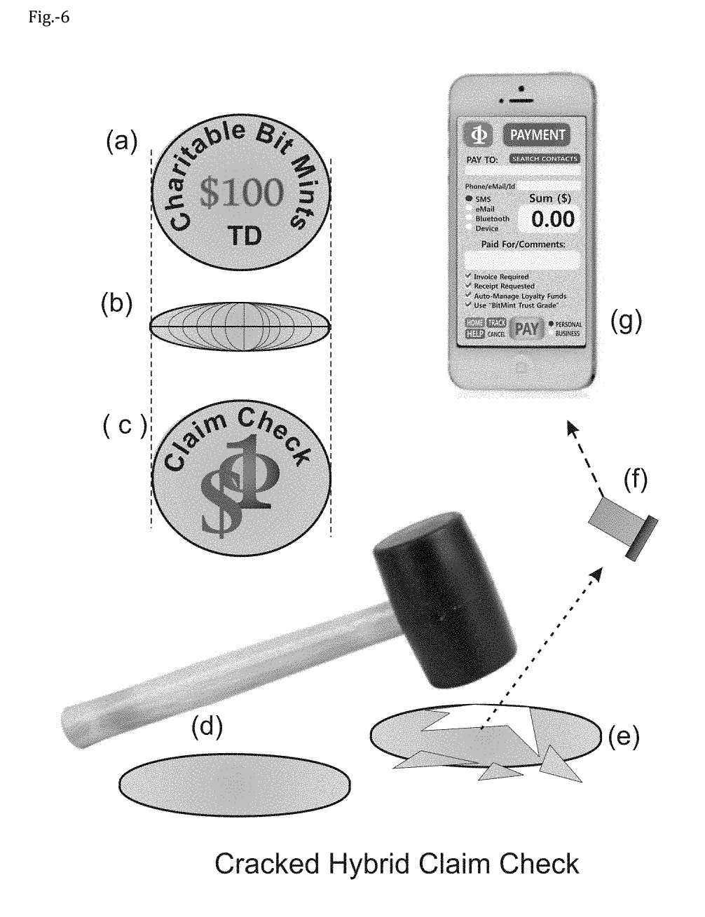

### INTRODUCTION

Charitable contributions help not only their recipients, but also, and in a subtle and profound way—the giver. Indeed we find charity givers among the poorest, and among those for whom this is a big sacrifice. It would be a very powerful idea then to offer anyone, anywhere to be a giver, a contributor. The CBM concept is such an idea: it offers a sense of giving and contributing to a worthy cause without the burden and the “pain” that is usually involved in separating one from his or hers hard earned money.

The preliminary idea is to induce members of the public to lend money to a financial institution, which in turn will invest the lended sums in an income-oriented fund. The income so produced minus all expenses in making it happen, will be routed to a worthy cause, while the invested funds themselves will be returned to the lenders.

This arrangement will tax the contributor with a temporary unavailability of his or her money. It is this very unavailability that the CBM concept alleviates, as follows:

The money lender will be receiving a digital claim check, a receipt if you will, with which he or she will be able to claim their loan, when its return is due. This claim check is so structured that it can be divided to smaller parts, small as desired, and each such part represents a claim check to a proportional part of the loan. Such claim checks parts can be offered in lieu of money to anyone to whom a claim check holder is about to pay a sum of money.

Why would a payee accept a claim check instead of cash per se? For the same reason that the original loan maker made the loan: to support the universal charity.

Suppose that Alice reads about the CBM arrangement which happens to support the American Cancer Society. She has good reasons to support the fight against cancer, and hence she logs into the proper web site, uses her credit card, and loans to the investment fund the sum of $100. She gets a digital claim check downloaded to her phone, and managed by the CBM applet (app). The digital claim check states its par value, of course, and it comes with an indication of the day it was issued, and the day it is eligible for par value redemption. Let's say Alice makes the loan on February 1st, and the claim check specifies May 1st as the earliest redemption day. Of course the claim check may be redeemed at any day later than the set forth redemption day.

Nominally Alice has lost the use of these $100 for a period of at least three months. Albeit, the claim check is issued in a cryptographic manner that allows Alice to use the money she has loaned. Suppose Alice wishes to pay Bob $20. Instead of handing Bob a $20 bill, Alice will propose to Bob to pass to him a $20.00 worth for her claim check. Suppose she does so on March 1. She will then tell Bob: “In two months you can redeem this claim check, and get the $20.00 I owe you”.

Let's assume now that Bob frowns on this proposal, and insists on getting his money free and clear. Alice might oblige, and move on to propose the same to Carla to whom she may wish to pay, say $30 for some reason. But then again, Alice might explain to Bob: “By taking this claim check you don't lose much, just a short wait, at most, and in turn you do help a worthy cause. I myself am committed to hold $100 of a loan for the duration, so if you take this $20.00 worth of claim check from me, I would make an additional par loan (of $20.00) to this worthy cause. You too wish to beat cancer, don't you, so why not help out?”

And what's more, Alice continues, “You don't have to sit on this claim check, you may offer it for your payments, and much as I have talked you into helping out with this cause, so will you, with the people you wish to pay to.”

The above scenario illustrates this remarkable situation where Alice has parted with her $100, but is also using the same money for her daily payments. It's like “magic” or, say, “Ghost payment”. Alice uses moral pressure over Bob to bring him into the ‘game’, and Bob does the same with his payment partners. Before long a viral effect takes hold, and there is no limit to how much this can spread, as more and more participants realize they actually lose nothing by lending money to the cause and receiving a tradable claim check in return. They lose nothing, and gain a lot: a sense of being givers, contributors to a very worthy cause.

One can envision how merchants and retailers will boast: “We accept charity bit mints!”. Over time the claim checks will be readily accepted without much ado, and the more so, the more willing will people be to lend money to the cause—they lose nothing, they gain a lot! There is no set limit to how big the fund will grow, and how much contribution to the cause it will generate.

The big picture is that a growing portion of the payment regimen whether face-to-face or in cyber space, will be carried out, not with nominal money but rather with Charity Bit Mints—with digital claim checks. These claim checks will be managed on payers' phone, tablet, and other computing devices. They will be texted, passed around as email attachment, or printed out on plane paper, using, say, bar code, which is readily re-read electronically. So without much ado the nominal payment modality where one account on the cloud is debited, while another cloud-based account is credited, is replaced with a straight forward transfer of a bit string that functions as a money claim check. This implies that people would be able to dine in a restaurant without disclosing this fact to the credit card company, because they will be paying with a claim check that passes as cash—not a credit card, not a credit card number, no identity theft vulnerability. These are all benefits emerging from exercising payment via digital claim check. As we see later this anonymity mode is optional, and may be replaced with full or partial accountability.

One can envision that claim checks keep circulating past their redemption date because as long as they are not redeemed, the money helps the cause, and there should be no difficulty at all to pass along a claim check beyond its redemption date, since the recipient can redeem it instantly.

This CBM idea is based on a new technology that enables digital claim checks. They can be issued securely, conveniently, and in a form that allows them to be divided at any desired resolution including micro payments, if needed. An example for such a capability may be seen in the technology expressed in U.S. Pat. No. 8,229,859, which is implemented in the BitMint technology, offered by the holders of this patent.

The name Charity Bit Mints is derived from the underlying BitMint technology on one hand, and from the use of Bits to build a digital claim check together with the interpretation of “mint” as a vast amount on one hand, and as a place where money is manufactured, on the other hand. After all, the digital claim checks, as they pass around like cash, may be regarded as a de-facto form of money.

### CBM: SYSTEM, PROCEDURE, METHODOLOGY

The CBM system is comprised of the following “players”

The CBM Company

The Participating Income Fund

The Charity Beneficiary

The Digital Claim Check Operator

The Trading Public

The system will require a website portal, a phone app, a promotion campaign, and an operational manual. A set of the above players and the listed constructs will be referred to as a CBM setting. There might be several settings benefitting different beneficiaries, using different Income Funds, incorporating different Digital Claim-Checks

Operators (CCO), and operate over different, or the same, trading public. The CBM company can operate all the CBM settings directly or perhaps through a franchise configuration, etc.

### The CBM Concept

The CBM idea is to lure the public to make and receive payments via a digital claim check which is redeemable in US dollars (or in any other prevailing currency), but is not US dollars per se (sort of “ghost money”). The underlying dollars are at the same time accumulating into an investment fund that generates profits which are routed to a universal charity. Potentially all the current payments that are transacted in dollars can be equally well, and in greater convenience transacted via digital claim checks, leaving a huge fund of US dollars to be conservatively and smartly invested to generate large profits, all dedicated to the subject charity. In fact, the potential is so huge that the resultant fund will be too big to invest anywhere. But such “limiting case” is a theoretical limit, and anyway quite far off. For the foreseeable future transforming a tiny fraction of US payments from trading with cash to trading with cash claim checks will be extremely consequential as a charity leverage.

### The CBM Dynamics

A promotional campaign will induce people to contribute to the declared universal charity by loaning money to the CBM company for a set period, T (say 6 months or a year). Lenders will receive a digital claim check comprised of a bit string that identifies the amount of the loan, and provides an id to this claim check. This digital claim check has the property that it can be divided to any resolution, and passed around as one or more bit strings, each carries its monetary redeemable value, such that the sum total of the values of these bit strings is the value of the original claim check. Each such “split string” or “sub-string,” or “derived string” will carry in it the information that identifies its day of redemption.

The ability to split a digital claim check to any desired resolution will allow the lender to pass it around as “payment” (no need for change). Recipients are expected to be reluctant, and refuse to receive these digital claim checks instead of nominal money. So the lender will try again with the next payment partner. The argument for acceptance of the digital claim checks is that by so doing the recipient is losing nothing much, and by contrast, helps much to a universal cause, like searching for a cure for cancer. It's the moral pressure of an important charity that will counteract against the natural reaction to refuse it.

Payees will readily understand that at most they will have to wait until the redemption day to claim their money proper. The success of the CBM concept depends on the expectation that the moral pressure to accept the claim check will overcome the resistance to have anything to do with it. This first phase, of “priming” a system may be slow, in as much that only a small percentage of payees will bite into this “spiel”. But as long as a small cut of payees consents to accept the claim check in lieu of “real money”—the CBM concept will work. Over time the CBM will become more and more acceptable. A viral progression starts slow, and picks up speed as it goes along. All the while the CBM promotion and priming campaign will extract more and more money from the public. All the money so assembled will be routed to an established, reputable financial institution which will collect these moneys into an investment fund, and invest the money wisely.

On a periodic basis the financial institution will separate the profits from the sunken fund, (the invested sums), deduct its own profit, and pass the balance to the CBM company which will pay its expenses, especially the cost of the claim check operator, and the cost of the promotion campaign, and pass the remaining balance to the institute that is dedicated to the declared charity cause. This passing is the object of the entire CBM initiative.

Claim checks may be submitted for redemption by their current holder when their redemption date arrives (marked on the claim check), and the money will be readily deducted from the investment fund managed by the selected financial institution.

On the other hand, claim checks that reached their redemption date (the maturity date) will now really function as well as money. A reluctant recipient will be readily persuaded with the argument: “If you don't find anyone to pass these claim checks to, then simply redeem them, no harm done!”. These instantly redeemable claim checks may linger and be used for normal payment—the longer, the better for the charity cause.

It is envisioned that stores and merchants in general will elect to boast: “We Accept Charity Claim Checks” asserting their good corporate citizenship. It is expected that media coverage will be positive (no negative side effects), and the publicity will increase the volume of the claim checks, and hopefully the number and dollar volume of claim checks redeemed at any given day, will trail the number and value of newly issued claim checks.

The financial institution that manages the money through income-maximizing funds will handle the volume fluctuation, accept the stream of new money, and redeem per requests the redeemable money. The longer the average life of the de-facto claim check, the lower can be the mandatory ‘wait for redemption’ time, and the greater the attraction of the CBM.

### Risk Sharing

Since the mechanism for generating contributions to the charity cause is based on investment, which in turn has a risk parameter, it becomes a fair question: what level of risk to assume.

The basic solution described above calls for the financial institution to, on one hand, making a profit from successfully managing the charity fund, and, on the other hand, assuming the losses for a fund that ends up in the red. But such modality will drive the fund manager to stay extremely conservative, and hence, harvest a poor income—meager charity contributions.

To remedy this issue, it is possible for the contributing public and the financial institution to share the risk according to some pre agreed formula. Say up to 5% loss, the financial institution will cover it, greater losses will result in redeeming the claim checks at less than par value.

Such risk sharing arrangement will clearly serve the cause of maximizing the benefit to the charity by venturing out to higher yield and higher risk investment avenues. It might be difficult to pull off when it comes to the public at large, but only experience will tell. On the other hand, such risk sharing arrangement is quite likely with respect to closed groups, and limited size public.

### The Players

The CBM system is comprised of the following “players”:

The CBM Company/Enterprise

The Participating Financial Institution

The Charity Beneficiary

The Digital Claim Check Operator

The Trading Public

### The CBM Company

The Charitable Bit Mint Company is the organizing enterprise that brings together the other players. It builds the economic structure. Itself, the financial institution that invests the funds, and the digital claim check operator will all claim their operating profits from the income that is generated from the invested funds. This will insure that the participants don't pay any commission to either buy, or redeem the money.

The CBM company may be a for profit, or non for profit enterprise. It will have to cover its expenses which will be (i) overall enterprise management, (ii) paying the digital claim check operator for its services, (iii) promotional campaign. Possibly, in order to prime the operation and get going, the CBM company might offer the public to lend $90.00 and redeem $100.00 after the redemption period.

The CBM company will be responsible to optimize the operation in terms of redemption time, selecting a competitive financial institution and an effective digital claim checks operator. The CBM company will also select the proper charity recipient, and codify and streamline the operation, and eventually perhaps, offer a franchise for other targets in terms of contributing public, or in terms of different charities.

### The Participating Financial Institute

The role of the participating financial institution is to use its market savvy to invest the money loaned to it from the public. Such investment will likely be highly conservative, because the institution will have to guarantee the return of the nominal funds invested. (in the base mode, where the public assumes no risk). Namely, in case the value of market goes negative, the institution will have to pitch in and make it whole. Of course a financial institution may choose to invest in fixed income instruments most of the funds, and allocate only a small portion to potentially higher yield, but higher risk. As the CBM concept becomes more popular financial institutions will likely compete and offer competitive terms in order to be awarded this account.

On a periodic basis the institution will take out the profits from the investment, deduct its management fee, pass the balance to the CBM company, which in turn will deduct its expenses, and profits (if any) and pass the balance on, to the charitable cause.

The invested fund will have peculiar dynamics: small daily amounts of new funds will be flowing in, and similar (hopefully smaller) amounts of funds will be redeemed and removed from the invested fund. This fund fluctuation may be easily managed by the CBM company holding a buffer, and exchanging money with the fund in big chunks, every set period.

The participating financial institution will have to be of high repute to assure the public that their money is well handled.

It is expected that financial institutions and investment funds will compete for the role of CBM investor because (i) it is profitable, management fee are deduced, and because (ii) it's good publicity and an opportunity to showcase its prowess.

### The Charity Beneficiary

The charity beneficiary should serve a cause of broad appeal in order for the claim checks to be accepted by many. It will have to have the proper reputation so that contributors will be assured that their contribution is not mishandled. The beneficiary will be well served if it participates in the promotion efforts to get this initiative going.

### The Digital Claim Check Operator

The Digital Claim Checks Operator will assume the responsibility to manage the digital claim checks in a way that would prevent fraud and abuse. It would have to prevent double redemption and it will have to prevent fake digital claim checks resulting in undue payment to the redeemer. This will require top security database, and advanced cyber security measures.

The Digital Claim Checks Operator will have to provide for the technology to allow the claim checks to be parceled out at any resolution, so that they can be traded cash-like online.

The Digital Claim Checks Operator will have to construct a very effective and smooth web portal that would cater to the current behavior of the public: mobile capabilities, alongside more traditional PC communications. A user-friendly smart phone app will also be necessary. The required efficiency will apply both for buying claim checks (lending money), and for redeeming claim checks (withdrawing deposits).

### The Trading Public

The trading public may range from the public at large—everyone in cyberspace regardless of locality; to the other extreme: the paying public as a closed group, which is naturally committed to the charity object served by the CBM concept.

The closed group option allows for pre-agreement to trade with the digital claim checks, and a similar agreement to lend large sums for the investment fund. Also a closed loop may agree on risk sharing with the financial institution per the eventuality of losses. In some cases the agreement might include outright contribution to the cause. The participating lenders will agree to be redeemed not at 100% of their loaned fund, but a portion thereto.

### Parallel Operations

A CBM setup comprised of the standard players operated over a given public, may be emulated and give rise to a different setup with different players operating according to the same or similar protocol, but serving a different charity over the same or different public. In fact there may be several such setups. If they operate over different publics they are not in competition, if they operate and apply to the same public then they compete for the sense of generosity of the same public. Hence, a potential payee might agree to be paid with claim checks that benefits, say, the US Veterans, but refuse to be paid with claim checks the benefit the blind people in the country.

It would not be very productive for different setups to compete over the same public because the power of the CBM concept comes to full expression when a large public is served by a single setup, and then these claim checks are de facto recognized as cash, and are widely accepted, meaning: the funds go larger and larger. To that end it might be a good idea to line up several deserving charities and divide the CBM profits among them according to some agreed upon formula. The paying public, though, will have a single type of claim check to deal with.

### Rules & Protocols

The CBM operation would have to comply with a tight, well-defined code of conduct and responsibilities. A detailed protocol for dispute resolution will have to be set forth, especially since the claim checks operate like money.

The monetary aspect of the CBM concept requires it to comply with the relevant requirements levied on money transfer operators, especially with respect to money laundering.

### Implementation Notes

It is important to make the CBM payment ubiquitous and integrated.

Ubiquitous: CBM payments will have to be readily applicable anywhere anytime, online and offline. There will be phone applets allowing for direct texting of claim checks, and existing digital wallets will have to be modified to account for the claim checks as integrated with the normal payment.

When Alice wishes to pay a merchant for a piece of merchandise, she might use her smart phone (like with Apple Pay today). Her phone and the payment portal of the merchant will join in a dialogue where Alice's machine will say: “I agree to pay you, say, $80.00 for the merchandise. I have $50 in charitable claim checks—would you accept them?” The merchant's computer will respond: “Please identify the type of claim checks you have”. Alice's machine will read off the claim check all the identity information that would communicate to the merchant the particular CBM implementation under which these claim checks are issued, the charitable cause will be identified, and the beneficiary for this cause too. The merchant's machine will have built in policy guidance: accept this type of claim checks, and reject the other type. The merchant policy might even dictate that only 50% of the cost of the merchandise can be passed on via claim checks rather than normal payment, or it may issue a dollar limit, etc.

Once the CBM claim checks are OKed, they are securely passed, and the protocol then proceeds to add the remaining $30 in “proper money”.

The digital claim checks can readily be printed out on paper, the paper being handed out to the recipient, like paper bills, and then the recipient using a bar code reader to read the claim check electronically, as if the claim checks were passed phone to phone.

An interesting option is possible in the form of hybrid coins: these are tamper-evident gadget in shape, size and feel of a regular coin today, say a quarter. The gadget is tamper-evident meaning: while it may be easy to crack it, it is very hard to conceal this cracking. Such an hybrid coin, will be passed around off line, as regular coins are passed around today. Each hybrid coin will have posted its par value, and its redemption date. The holder of such a coin can readily crack it, pull out from inside a micro SD or an equivalent contraption that functions as a bit memory and then electronically read the bits inside. These bits together will amount to a digital claim check that may be redeemed via the CBM company in a normal manner.

The passed around hybrid coins may survive way beyond their redemption day, as holders choose to keep serving the charitable cause underwritten by such coins.

### Accounting and Traceability

In its base mode the claim checks are payable like cash—untraceable. This implies that people can accumulate claim checks and use them in lieu of cash for the purpose of hiding their purchases. This might be an issue in today's day and age. A remedy can readily be found by applying tracing technology to the claim checks. Namely, each time a claim check will change hands, the payer and the payee will be digitally identified (explicitly or in some coded way), along with the time of the transaction. This means that a digital claim check will carry with it as a bit trailer, its entire trading history. Such wealth of information amounts to complete “sun shine” and full exposure, leaving no room for underhanded practice.

This full accounting mode will enable an accurate reporting of contributions to the cause. Each participant in the CBM operation will get an annual report, or quarterly report, from the CBM company, of how much money he or she (or it) actually contributed to the cause. This figure will be computed by the CBM company by analyzing all the claim checks submitted for redemption, and recording for each such claim check, for whatever amount, who owned it for how long a time. So the CBM company will know that Alice, during the past year, handled 2300 different claim checks for different amounts. The CBM company will know that Alice held claim check with ID=xxx at par value of $50, for 7 days, and then she passed $20 thereof to Bob, who eventually redeemed it. Alice will be credited for lending the charity the amount of $20 for 7 days. The balance of $30 she paid later, and it will be accounted later. The CBM company will compile these bits and pieces of amounts held over however many days. The company will have the record for the last year that says that the net contribution to the cause, was, say 4% relative to the invested funds. Accordingly, the $20 claim check held for 7 days contributed to the cause the amount of: 20*(7/365)*0.04 dollars. These dollars are then integrated over all the claim checks that Alice held and that were redeemed in the past year, and the sum total is the exact amount credited to Alice for her CBM participation. The most generous contributors will be recognized and honored, and create a public attraction to do good, and be socially recognized for it.

### Figures

Should 1,000,000 people hold on average $100 worth of claim checks in their digital wallet, this would amount to $100,000,000, invested with a net yield, say, of 4%, on an average year—resulting in cash contribution to the served cause at a rate of $4,000,000 annually. And if participation climbs to 50,000,000, then the served charitable cause will be receiving $200,000,000 annually.

### SUMMARY

This invention describes a method named “Charitable BitMints” that creates an economic leverage by building trust in digital money claim checks such that these claim checks serve as payments in ordinary transactions while the claimable money is used in the form of an investment instrument, and thereby the claim checks traders support the beneficiary of these instruments without harm or cost to themselves since payer and payee exhibit trust in said claim checks.

The beneficiary of the investment instrument is a widely respected charitable organization, allowing for a public promotion of the method to create public acceptance of the digital claim checks on account of the fact that every dollar traded as dollar claim check is a dollar that is part of an investment fund (instrument) that builds a yield that benefits said charitable organization.

Optionally the issued claim checks are tied to an earliest redeemable date before which the claim checks are not redeemable.

The issued claim checks may be implemented according to the format described in U.S. Pat. No. 8,229,859.

The player in this method are (i) a Charitable BitMint enterprise, which may involve the digital claim checks operator, (ii) participating, trading public, (iii) an investment bank, and (iV) a widely respected charitable organization. The public trades fiat currency (e.g. US$) against charitable money claim checks at par value, and uses these claim checks in lieu of ordinary payment; such payment being widely accepted as cash equivalent on account of their moral value to the benefiting charitable organization. The paid currency for which the claim checks were issued is used by an investment bank in a form of an investment instrument. The yield of this investment is used first to cover the management fee of the investment bank, second to pay for the cost and fee for the Charitable BitMint enterprise, while the balance is forwarded to the charitable organization

What is claimed is:

1. A method named “Charitable BitMints” that creates an economic leverage by building trust in digital money claim checks such that these claim checks serve as payments in ordinary transactions while the claimable money is used in the form of an investment instrument, and thereby the claim checks traders support the beneficiary of these instruments without harm or cost to themselves since payer and payee exhibit trust in said claim checks.

2. A method as in (1) where the beneficiary of the investment instrument is a widely respected charitable organization, allowing for a public promotion of the method to create public acceptance of the digital claim checks on account of the fact that every dollar traded as dollar claim check is a dollar that is part of an investment fund (instrument) that builds a yield that benefits said charitable organization.

3. A method as in (1) such that the issued claim checks are tied to an earliest redeemable date before which the claim checks are not redeemable.

4. A method as in (1) such that the claim checks are issued as digital representation of money according to the specification in U.S. Pat. No. 8,229,859.

5. A method as in (1) such that it involves: (i) a Charitable BitMint enterprise, (ii) participating public, (iii) an investment bank, and (iV) a widely respected charitable organization, and where the public trades fiat currency (e.g. US$) against charitable money claim checks at par value, and uses these claim checks in lieu of ordinary payment; such payment being widely accepted as cash equivalent on account of their moral value to the benefiting charitable organization, and while the paid currency for which the claim checks were issued is used by an investment bank in a form of an investment instrument, and where the yield of this investment is used first to cover the management fee of the investment bank, second to pay for the cost and fee for the Charitable BitMint enterprise, while the balance is forwarded to the charitable organization.
